(19) United States
(12) Patent Application Publication
(10) Pub. No.: US 2010/0263495 A1
(43) Pub. Date: Oct. 21, 2010

(54) Device for a Power Tong

(75) Inventor: Jonathan Garrick Webb, Kristiansand (NO)

Correspondence Address: Conley Rose P.C, P.O.Box 3267, Houston, TX, 77253, US

(73) Assignee: NATIONAL OILWELL VARCO NORWAY AS

(21) Appl. No.: 12/740,909

(22) PCT Filed: Oct. 30, 2008
(86) PCT No.: PCT/NO08/00382

§ 371 Date: Jun. 23, 2010

(30) Foreign Application Priority Data
Nov. 1, 2007 (NO) 20075521

(51) Int. Cl. B25B 13/50

(52) U.S. Cl. 81/57.33

(57) ABSTRACT

A device for a power tong (1) for unscrewing or screwing a pipe (6) comprising a tong housing (2) with a radial opening for moving the pipe (6) into or out of the power tong (1), at least one driving motor (40, 52) with associated transmission elements (61), and a tong portion (39) including at least one gripper (24), the at least one driving motor (40, 52) being arranged to rotate the tong portion (39) with the at least one gripper (24) about a centre axis (4), and the tong portion (39) comprising an arm case (8) with a radial arm case opening (17) and a step case (28) with a radial step case opening (37), a first driving motor (40) being coupled the to the arm case (8) and releasably coupled to the step case (28) by means of transmission elements (61), and a second driving motor (52) being coupled to the step case (28) and releasably coupled to the arm case (8) by means of transmission elements (61).

This invention relates to a power tong. More particularly, it relates to a power tong for screwing or unscrewing a pipe, the power tong including a tong housing with a radial opening for moving the pipe into or out of the power tong, at least one driving motor with associated transmission elements, and a tong portion including grippers, the at least one driving motor being arranged to rotate the tong portion with the grippers about a centre axis. The tong portion includes an arm case with a radial arm case opening and a step case with a radial step case opening, a first driving motor being coupled to the arm case and releasably coupled to the step case by means of transmission elements, and a second driving motor being coupled to the step case and releasably coupled to the arm case by means of transmission elements.

The terms arm case and step case are used to facilitate the explanation of the operation of the power tong. These terms do not in any way limit the scope of the invention, as other terms for these bodies, for example first and second tong portions, might have been used just as well.

Power tongs are often used for unscrewing or screwing pipe lengths in, for example, a drill string for drilling in the ground.

A power tong may form part of a more or less automated facility for carrying out said screwing operations. Power tongs are generally divided into two main groups: open and closed power tongs. By an open power tong is meant, in this connection, a power tong which is typically U-shaped and provided with a radial opening, the power tong thereby being arranged to be moved radially in and out relative to the pipe.

In addition to the actual make-up and break-out operations, automated power tongs must most often carry out the so-called spinning operation, in which a pipe is rotated fast about its longitudinal axis. Thus, it must be possible for the gripping means of the power tongs to rotate more than one turn about the centre axis of the pipe. Open tongs must thereby be closed in order to carry out the spinning operation, and many different solutions are known for enabling the closing of an open power tong. These solutions have in common that they are relatively complicated and partly also sensitive to damage.

Closed power tongs, which are often of relatively simple construction, have the substantial weakness of not being radially movable away from the pipe when the pipe has been made up. There are also power tongs which are closed during operation, but in which there is arranged a gate which can be opened for the power tong to be moved over the pipe.

The clamping force of the power tong against the pipe is provided, according to technology known per se, by means of mechanical or hydraulic clamping. In mechanical clamping the clamping force against the pipe is often dependent on the relevant torque about the pipe, which is unfortunate, especially when relatively thin-walled pipes are used.

Hydraulic clamping of the pipe enables a relatively accurate control of the clamping force and is often preferred because of that. Hydraulic clamping devices require hydraulic pressure fluid to be supplied to the rotatable tong, which may be complicated in itself. Hydraulic clamping cylinders often have a relatively limited working range.

From the documents RU 2026484, US 2005/0011312 and US 2006/0011017 is known the tightening of the gripping means by means of a cam, the gripping means being pivotably connected to a portion which is rotatable relative to a cam portion.

The invention has for its object to remedy or reduce at least one of the drawbacks of the prior art.

The object is achieved in accordance with the invention through the features which are specified in the description below and in the claims that follow.

A power tong in accordance with the invention for screwing or unscrewing a pipe comprising a tong housing with a radial opening for moving the pipe into or out of the power tong, at least one driving motor with associated transmission elements, and a tong portion including grippers, the at least one driving motor being arranged to rotate the tong portion with the grippers about a centre axis. The tong portion comprises an arm case with a radial arm case opening and a step case with a radial step case opening. The power tong in accordance with the invention is characterized by a first driving motor being coupled to the arm case and releasably coupled to the step case by means of transmission elements, and a second driving motor being coupled to the step case and releasably coupled to the arm case by means of transmission elements.

According to another aspect of the power tong, the arm case is provided with at least one pivotable torque arm which is arranged to be pivoted between an inactive, swung-out position and a swung-in, active position in which it bears on the pipe via the gripper. A tensioning arm is connected to the toque arm near the gripper, the free end of the tensioning arm being selectively placed, in its active position, in a stepped block. The stepped block forms part of the step case.

According to a further aspect of the power tong, the first driving motor is coupled to a first toothed rim on the arm case by means of a first motor shaft and a first toothed wheel, and to a second toothed rim located on the step case, by means of the first motor shaft, a first coupling, a first sleeve shaft and a second toothed wheel.

As in the above-mentioned aspect regarding the first driving motor, the second driving motor is coupled to the second toothed rim, which is located on the step case, by means of a second motor shaft and a third toothed wheel, and to the first toothed rim on the arm case by means of the second motor shaft, a second coupling and a fourth toothed wheel.

The opening and closing operations of the tong portion will be explained in detail in the particular part of the description and is not described any further here.

The stepped block is provided with several steps, the steps being at different radial distances from the centre axis.

With advantage, the torque arm is pivotable about a pivot axle. The tensioning arm is connected, as mentioned, to the opposite end portion of the torque arm relative to the pivot axle, where also the gripper is. The free end portion of the tensioning arm fits complementarily into one of the steps of the stepped block. Which step the tensioning arm is placed into is selected on the basis of the pipe dimension and desired clamping force.

The positioning of the tensioning arm relative to the stepped block is controlled by a control system, based on signals from rotary encoders and selected pipe dimension and desired clamping force, by relative rotation of the arm case and step case in a first direction into the desired relative position. The tensioning of the torque arm against the pipe is carried out by relative rotation of the arm case and step case in the opposite direction. The tension force will be greater if the tensioning arm lies in a step which is at a greater distance from the centre axis than if the tensioning arm is in a step closer to the centre axis, see figures in the particular part of the description. In addition, the clamping force is controlled by means of the torques of the driving motors, the clamping force increasing, because of the geometry of the arms, when the relative torque between the arm case and step case increases.

When the gripping operation has been carried out, the arm case and step case are connected to each other rotationally, thereby co-rotating about the centre axis at the desired torque and speed.

With advantage, the gripper in the form of a gripping die is resiliently connected to the torque arm, possibly by means of an elastic material or a resilient structure, for example in connection with the tensioning arm. Thereby, minor radial movements during the operation can be absorbed without any change in the clamping force worth mentioning. Further, some elasticity in the tensioning will equalize jumps in the clamping force occurring because of a toothed engaging mechanism in the first and second couplings, and steps in the stepped block.

The couplings are often of such design that they may be engaged in rotational steps. This results in the arm case and step case being interconnectable in steps, which causes the resulting clamping force against the pipe also to be selectable in steps. These jumps in clamping force will be equalized somewhat by means of said springing effect.

The device according to the invention provides a power tong which combines the advantageous features of a mechanical open power tong with the advantageous features of a hydraulic closed power tong. The power tong according to the invention is arranged to be moved in radially over a pipe. The power tong grips by a controlled force which is substantially maintained during the operation, and which is unaffected by the torque of the power tong without the necessity of using hydraulic transmissions to the tong portion. Moreover, the tong portion is rotated mechanically about the centre axis by means of motors under constant engagement.

The tong structure enables the handling of pipes within a relatively wide range of dimensions without changing clamping dies.

In what follows is described a preferred embodiment which is visualized in the accompanying drawings, in which:

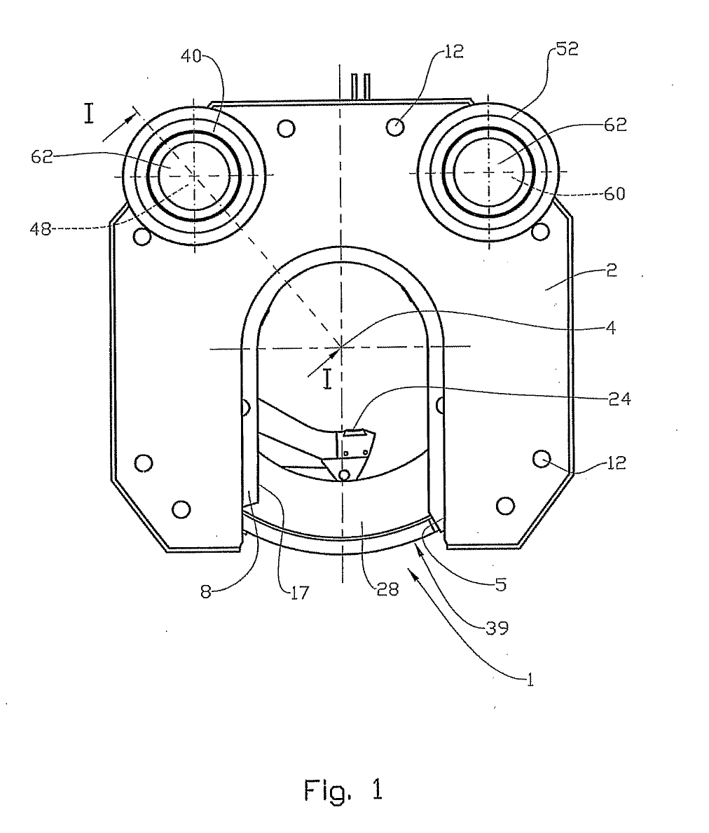

FIG. 1 shows a plan view of a power tong in accordance with the invention;

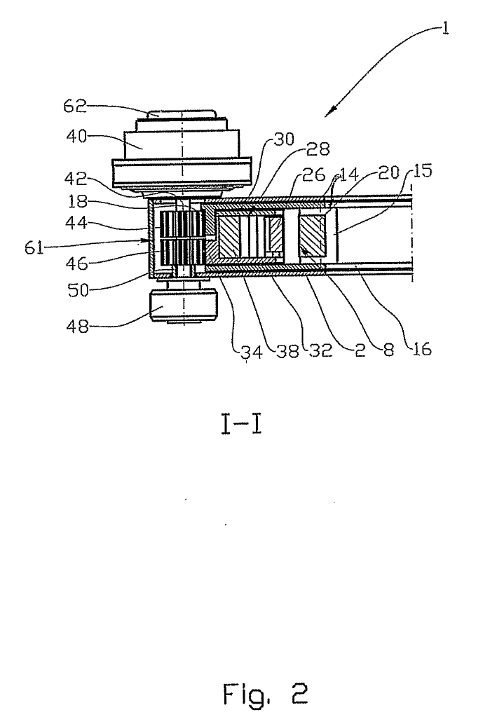

FIG. 2 shows a section I-I of FIG. 1;

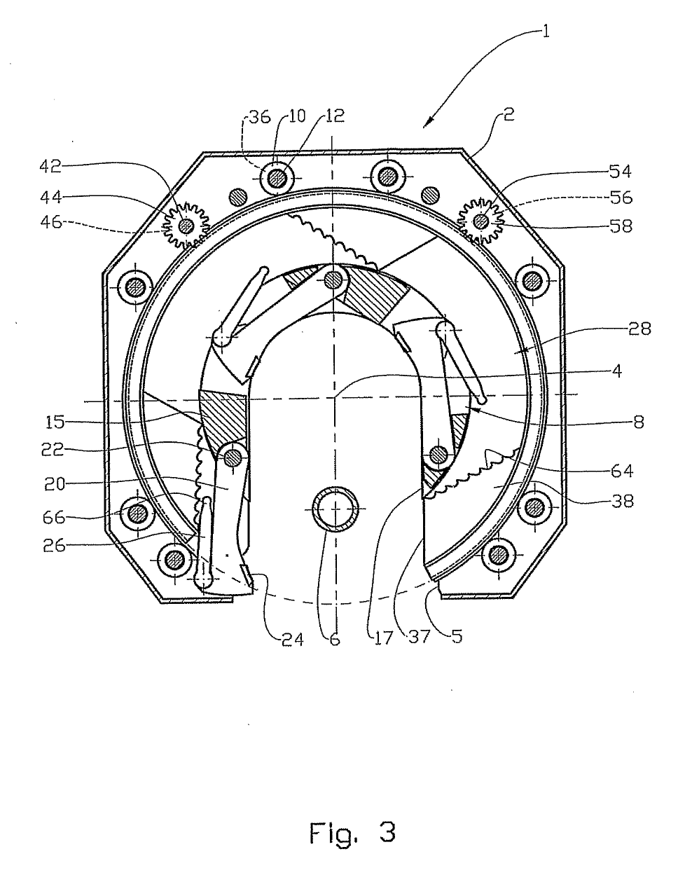

FIG. 3 shows a plan view, in which the power tong is open and in which plates have been removed to enable better illustration of the operation of the power tong;

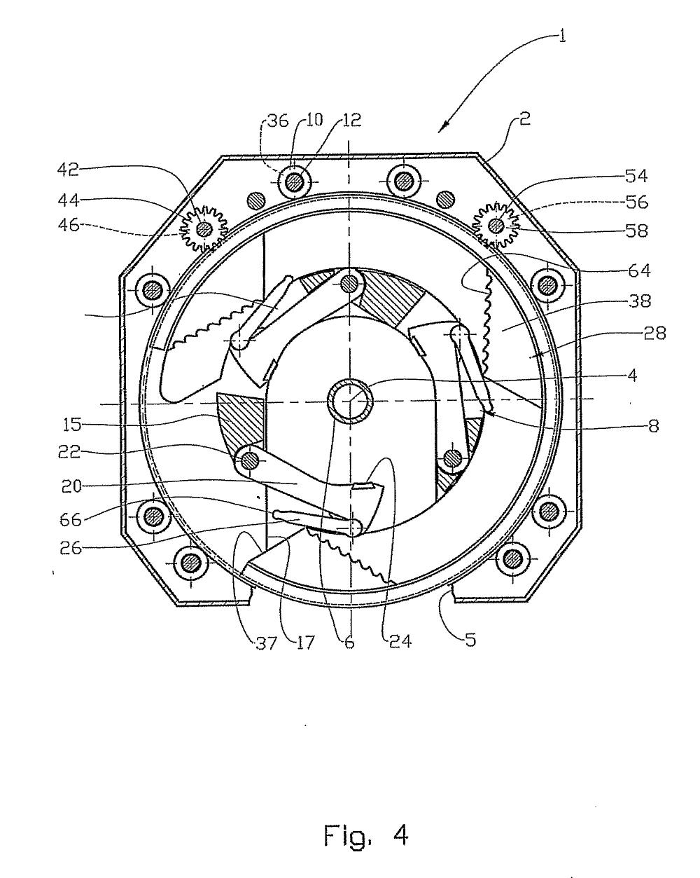

FIG. 4 shows the same as FIG. 3, but after the closing operation of the power tong has been started;

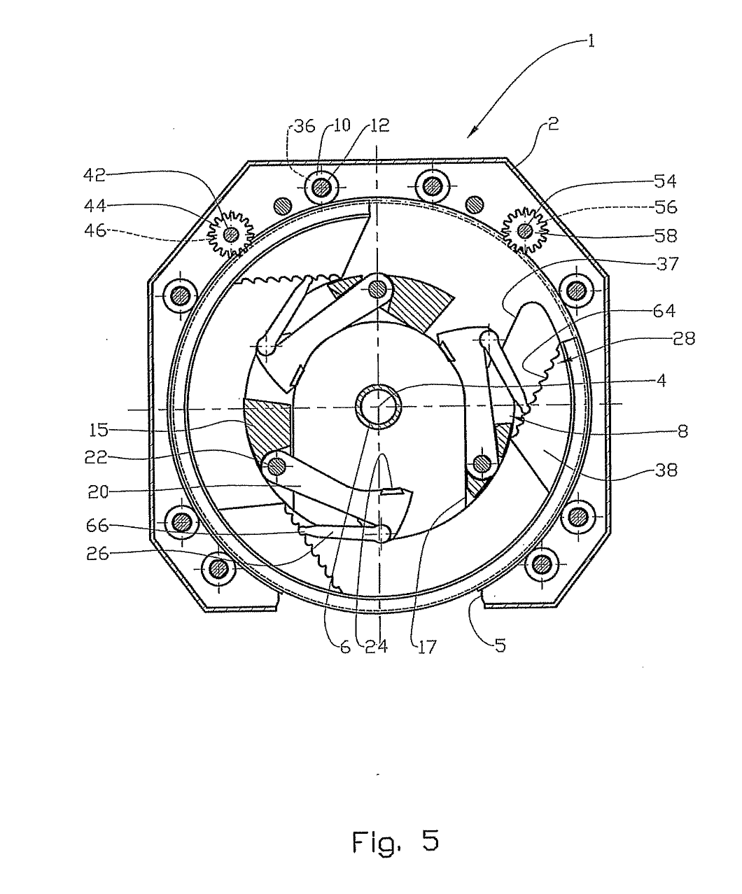

FIG. 5 shows the same as FIG. 4, but here the closing operation is in a phase in which the power tong is adjusted to the relevant pipe dimension; and

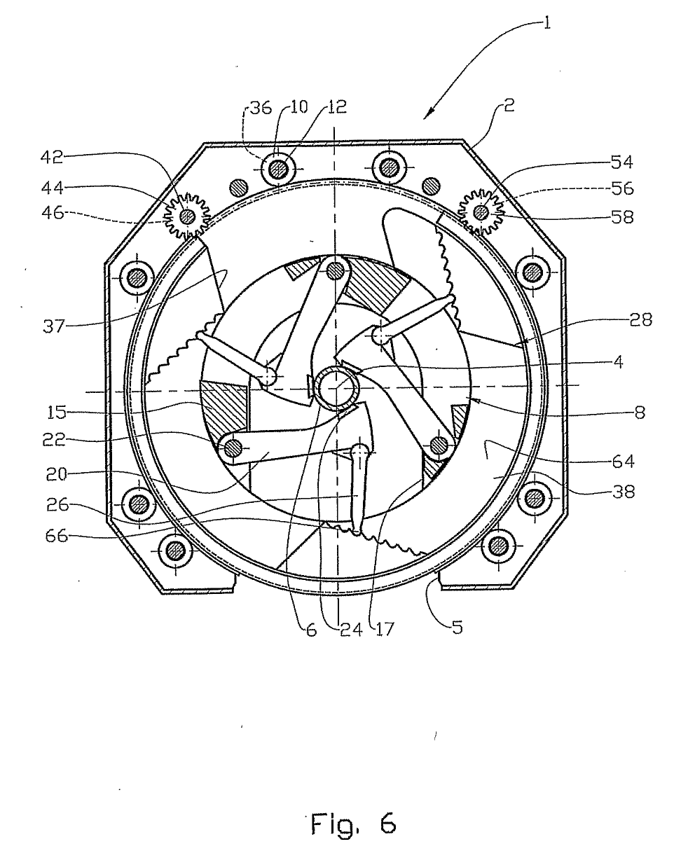

FIG. 6 shows the power tong engaging a pipe.

In the drawings the reference numeral 1 indicates a power tong which includes a tong housing 2, the tong housing 2 being approximately symmetrical about a centre axis 4. The tong housing 2 is formed with a radial opening 5 for moving a pipe 6 into or out of the power tong. The centre axis 4 corresponds to the centre axis of the pipe 6 when the pipe 6 is in a position for unscrewing or screwing in the power tong 1, see FIGS. 4-6. Necessary connections to a tong suspension and similar are not shown. The FIGS. 1 to 6 are simplified in relation to a practical embodiment in order to illustrate better the operation of the power tong.

A U-shaped arm case 8 is rotatably supported about the centre axis 4 in the tong housing 2 by means of a number of first centring rollers 10, see FIG. 3. The centring rollers 10 are supported about centring axles 12 in the tong housing 2. The arm case 8 comprises a first plate portion 14 and a second plate portion 16 which are connected by means of intermediate pieces 15, see FIG. 2. The plate portions 14, 16 are provided with a radial arm case opening 17. The arm case 8 is externally provided with a first toothed rim 18.

In this preferred exemplary embodiment the arm case 8 is provided with three pivotable torque arms 20 which are arranged to be pivoted about pivot axles 22 at their one end portions between an inactive, swung-out position and a swung-in, active gripping position. The pivot axles 22 are each located at a respective intermediate piece 15. At their opposite end portions, the torque arms 20 are provided with grippers 24 in the form of gripping dies facing the centre axis 4. The gripping dies 24 may be supported in an elastic material, not shown.

Near the gripping dies 24, but on the opposite sides, the torque arms 20 are each linked to a respective tensioning arm 26.

A U-shaped step case 28 is rotatably supported about the centre axis 4 between the first and second plate portions 14 and 16. The step case 28, which includes a third plate portion 30 and a fourth plate portion 32 with a second external toothed rim 34, is supported in a number of second centring rollers 36 and is provided with a radial step case opening 37. The centring rollers 36 are supported about the centring axles 12.

Between the third and fourth plate portions 32 and 34 are arranged stepped blocks 38 distributed about the centre axis 4 and arranged to cooperate with the tensioning arms 26.

The tong portion 39 of the power tong 1 comprises the arm case 8, torque arms 20, gripping dies 24, tensioning arms 26, step case 28 and stepped blocks 38.

A first driving motor 40 is secured to the tong housing 2 and, via a first motor shaft 42 and a first toothed wheel 44 in permanent engagement with the first toothed rim 18, drives the arm case 8 about the centre axis 4, see FIG. 2. The first motor shaft 42 extends freely through a second toothed wheel 46 to a first coupling 48.

The first coupling 48 is coupled to the second toothed wheel 46 by means of a first sleeve axle 50. The second toothed wheel 46 is in engagement with the second toothed rim 34.

When the first coupling 48 is activated, the first toothed rim 18 and the second toothed rim 34 are rotated synchronously by means of the first toothed wheel 44 and the second toothed wheel 46. When the first coupling 48 is disengaged, the second toothed rim 34 can be rotated independently of the first driving motor 40.

Correspondingly, via a second motor shaft 54, a second driving motor 52 is coupled to a third toothed wheel 56 which is in permanent engagement with the second toothed rim 34. A fourth toothed wheel 58, which is in engagement with the first toothed rim 18, is controllably coupled to the second motor shaft 54 by means of a second coupling 60.

The transmission elements 61 of the power tong 1 comprise the first toothed rim 18, second toothed rim 34, first motor shaft 42, first toothed wheel 44, second toothed wheel 46, first coupling 48, first sleeve axle 50, second motor shaft 54, third toothed wheel 54, fourth toothed wheel 58 and second coupling 60.

The driving motors 40, 52 are both provided with rotary encoders 62 which are connected to a control system, not shown, of a design known per se, and which has been programmed for the purpose. In this exemplary embodiment, the driving motors 40, 52 are hydraulic motors with several chamber configurations to utilize the fluid pressure and capacity available from a hydraulic system, not shown.

In FIGS. 3 to 6 the driving motors 40, 50, a portion of the tong housing 2 and also the first plate portion 18, third plate portion 30 and first toothed rim 18 have been removed for reasons of illustration.

When, for example, a pipe 6 is being unscrewed or screwed in the power tong 1, both the arm case 8 and step case 28 are oriented in such a way that the arm case opening 17 and step case opening 37 coincide with the housing opening 5. Thereby the pipe 6 can be moved radially into the power tong 1, see FIG. 3. All the three torque arms 20 have been swung out into their respective inactive positions.

As soon as the step case 28 is rotated clockwise by means of the second driving motor 52, the torque arm 20 which is nearest to the arm case opening 17 is swung by means of a cam, not shown, into a position corresponding to those of the other torque arms 20, see FIG. 4. Under continued rotation of the step case 28 while the arm case 8 is held stationary by the first driving motor 40, the tensioning arms 26, which are spring-loaded in an outward direction from the torque arms 20, are pivoted in towards their respective torque arms 20 by the stepped blocks 38.

The stepped blocks 38 are provided with a number of steps 64 at different radial distances from the centre axis 4. The steps 64 complementarily fit the free end portion 66 of the tensioning arm 26 facing, when the tensioning arm is active, away from the torque arm 20.

To ensure that the radial openings 37, 17 of the step case 28 and arm case 8 do not overlap during the screwing and unscrewing operation, the step case 28 is rotated further clockwise until the end portions 66 of the tensioning arms 26 correspond to the desired step 64 for the relevant pipe dimension, see FIG. 5.

The relative position of the arm case 8 and step case 28 is determined by means of the rotary encoder 62 and the control not shown.

By rotating the step case 28 anticlockwise while the arm case 8 is held at rest, alternatively is rotated in the opposite direction, the tensioning arm 26 is moved, thereby pivoting the torque arm 20 in the direction of its active position, in which it bears clampingly on the pipe 6.

When the desired clamping force on the pipe 6 is achieved, the couplings 48, 60, the first and second toothed wheels 42, 44, respectively the third and fourth toothed wheels 46, 58, are connected to each other rotationally, whereby the arm case 8 and step case 28 co-rotate about the centre axis 4 as a closed power tong.

By the radial openings 17, 37 not overlapping, at least the two toothed wheels 42, 44 located on the first motor shaft 42, or the two toothed wheels 56, 58 located on the second motor shaft 54, are at all times engaged with both the first and second toothed rims 18, 34.

The torque exerted by the driving motors 40, 52 during the gripping of a pipe 6 is thus independent of the torque exerted during the screwing and unscrewing of a pipe 6 or during fast spinning of the pipe 6.

1. A device for a power tong for unscrewing or screwing a pipe, the device comprising:
a tong housing with a radial opening for moving the pipe into or out of the power tong;
a first driving motor with first associated transmission elements and a second driving motor with second associated transmission elements; and
a tong portion including at least one gripper adapted to grip the pipe, wherein the at least one driving motor is arranged to rotate the tong portion with the at least one gripper about a centre axis,
wherein the tong portion comprises an about the centre axis rotatable arm case with a radial arm case opening and an about the centre axis rotatable step case with a radial step case opening,
wherein via the first associated transmission elements, the first driving motor is coupled to the arm case and releasably coupled to the step case, and
wherein via the second associated transmission elements, the second driving motor is coupled to the step case and releasably coupled to the arm case.

2. The device in accordance with claim 1, wherein the arm case is provided with at least one pivotable torque arm which is arranged to be pivoted between an inactive, swung-out position and a swung-in, active position in which it bears via the gripper on the pipe, a tensioning arm being connected to the torque arm near the gripper, the free end portion of the tensioning arm being selectively placed, in the active position, in a step of a stepped block, the stepped block forming part of the step case.

3. The device in accordance with claim 1, wherein the first associated transmission elements comprise a first toothed rim on the arm case to which the first driving motor is coupled by means of a first motor shaft and a first toothed wheel, and the first associated transmission elements further comprise a second toothed rim located on the step housing to which the first driving motor is releasably coupled by means of the first motor shaft, a first coupling, a first sleeve axle and a second toothed wheel.

4. The device in accordance with claim 1, wherein the second associated transmission elements comprise a second toothed rim located on the step case to which the second driving motor is coupled by means of a second motor shaft and a third toothed wheel, and the second associated transmission elements further comprise a first toothed rim on the arm case to which the second driving motor is releasably coupled by means of the second motor shaft, a second coupling and a fourth toothed wheel.

5. The device in accordance with claim 2, wherein the stepped block is provided with a plurality of steps spaced at different radial distances from the centre axis.

6. The device in accordance with claim 2, wherein the torque arm is pivotable about a pivot axle.

7. The device in accordance with claim 2, wherein the gripper is connected to the torque arm by means of an elastic material.

8. The device in accordance with claim 1, wherein the gripper is resiliently coupled to the torque arm.
